(19) United States
(12) Patent Application Publication
(10) Pub. No.: US 2019/0116170 A1
(43) Pub. Date: Apr. 18, 2019

(54) APPARATUS AND METHOD FOR CONTAINERIZATION AT A CLUSTER

(71) Applicant: General Electric Company, Schenectady, NY (US)

(72) Inventors: Veera Kishore Reddipalli, San Ramon, CA (US); Diwakar Kasibhotla, San Ramon, CA (US); Ashish Agrawal, San Ramon, CA (US)

(21) Appl. No.: 15/787,400

(22) Filed: Oct. 18, 2017

(51) Int. Cl. H04L 29/06; G06F 3/06

(52) U.S. Cl. CPC H04L 63/083; G06F 3/067; G06F 3/0643; G06F 3/0622

(57) ABSTRACT

Tenant-specific data required for use by a software analytic at an edge node is obtained. The software analytic is associated with a single tenant. The tenant-specific data and the analytic are transmitted from the edge node to a cluster of one or more software containers. Each of the containers at the cluster enforces a set of access privileges for files being accessed. The user data and the analytic are routed to a selected container within the cluster and the selected container executes the analytic such that the data accessed by the analytic at the container is protected from access by other tenants utilizing the cluster.

### CROSS REFERENCE TO RELATED APPLICATION

“Apparatus and Method for Multitenancy in Cloud Environments for Processing Large Datasets” having attorney docket number 9414-140895-US (320696), which is being filed on the same date as the present application and which has its contents incorporated herein by reference in its entirety.

### BACKGROUND OF THE INVENTION

### Field of the Invention

The subject matter disclosed herein generally relates to the protection of tenant data obtained from industrial machines, and, more specifically, to the enforcement of security policies based on the requirements of tenants and the provision of an infrastructure that isolates and customizes the needs of specific tenants.

### Brief Description of the Related Art

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. Other types of industrial assets may include vehicles such as fleets of trucks. The design and implementation of these assets often takes into account both the physics of the task at hand, as well as the environment in which such assets are configured to operate.

In an industrial internet environment, there is typically a need to analyze large datasets of time series data. Once the analysis occurs, various insights can be offered. In one example, a job is submitted to analyze plant data received from an industrial plant in order to calculate the heat rate of the plant. This requires the analysis of a large volume of data sets.

To maintain low costs and high productivity, and better leverage hardware resources, multi-tenant environments share clusters and nodes. In such an environment, it is required to protect the data of each tenant from unauthorized access by other tenants. As mentioned, large amounts of data are created by industrial machines. Because of the large amount of data that is created, processing of this data can take a lot of time across shared nodes and clusters. Additionally, security concerns exist when users inappropriately access the data of other users in these types of environments.

### BRIEF DESCRIPTION OF THE INVENTION

In the present invention, data security policies are enforced based upon the requirements of tenants. More specifically, this invention addresses the need to protect the data accessible to a job (for a particular tenant) by providing an infrastructure that isolates and customizes the needs of specific tenants resulting in the protection of tenant-specific time-series data.

In many of these embodiments, tenant-specific data required for use by a software analytic at an edge node is obtained. The software analytic is associated with a single tenant. The tenant-specific data and the analytic are transmitted from the edge node to a cluster of one or more software containers. Each of the containers at the cluster enforces a set of access privileges for files being accessed. The user data and the analytic are routed to a selected container within the cluster, and the selected container executes the analytic such that the data accessed by the analytic at the container is protected from access by other tenants utilizing the cluster.

In aspects, each of the containers at the cluster comprises one or more pre-programmed rules. In one example, the pre-programmed rules for each of the containers takes priority over file access requests made by the analytic.

In other aspects, the set of access privileges includes full access, partial access, or no access. In other examples, the files include data files or executable code files.

In other examples, an IP address and security credentials are utilized at the edge node to obtain the tenant-specific data. For instance, the security credentials may include a password or a key. Other examples are possible.

In some aspects, the access privileges at the containers of the cluster comprise a unique set of access privileges. In other examples, the access privileges may be the same or similar.

In others of these embodiments, a system that provides containerization of analytic execution at a cluster includes an edge node and a cluster. The edge node is configured to obtain tenant-specific data required for use by a software analytic. The cluster includes one or more software containers, and is communicatively coupled to the edge node. Each of the containers enforces a set of access privileges for files being accessed. The cluster is configured to receive the tenant-specific data and the analytic from the edge node. The cluster is configured to route the user data and the analytic to a selected container within the cluster, and the selected container executes the analytic such that the data accessed by the analytic is protected from access by other tenants utilizing the cluster.

In aspects, the containers comprise one or more pre-programmed rules. In other examples, the pre-programmed rules for each of the containers takes priority over file access requests made by the analytic. In still other examples, the set of access privileges includes full access, partial access, or no access.

In other examples, the files include data files or executable code files. In still other examples, the edge node utilizes an IP address and security credentials are utilized to obtain the tenant-specific data. In yet other examples, the security credentials include a password or a key.

In some examples, the access privileges comprise a unique set of access privileges. In other examples, the access privileges may be the same or similar for different tenants.

### BRIEF DESCRIPTION OF THE DRAWINGS

For a more complete understanding of the disclosure, reference should be made to the following detailed description and accompanying drawings wherein:

FIG. 1 comprises a block diagram of a system that containerizes the access and processing of data according to various embodiments of the present invention;

FIG. 2 comprises a flow chart of an approach that containerizes the access and processing of data according to various embodiments of the present invention;

FIG. 3 comprises a block diagram of a container at a cluster according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, security policies are enforced based on the requirements of tenants. More specifically, this invention protects the data accessible to a tenant-specific job, and also provides an infrastructure that isolates and customizes the needs of specific tenants resulting in the protection of tenant-specific time-series data. The infrastructure may include an edge node that communicates with a data cluster.

In aspects, a container is created at the cluster-level and has special privileges based upon a tenant so that any system-level commands that are part of an analytic being executed in the containers will only have the privileges entitled to that tenant. In examples, the privileges may relate to access privileges to data files or computer programs.

It will be appreciated that the approaches described herein can be deployed at various locations or combinations of locations. In one example, the edge node and the cluster are deployed at the cloud. In another example, the edge node and the cluster may be deployed at a local operating environment such as an industrial site. In still other examples, the edge node may be deployed at a local site and the cluster may be deployed at the cloud. In any case, the needs of specific tenants are isolated and customized such that data from each of these tenants is protected from unauthorized use.

In aspects, a software application that is being executed by a user desires to execute or requires the execution of a software analytic. The analytic (e.g., a rule or set of rules) may, for instance, examine the number of binary 1s and 0s from a sensor for one day from a windmill. In one example, 100 zeros indicate 100 MW of power has been generated by the windmill, and 50 zeros/50 ones indicate 50 MW of power has been generated.

The data from or used by different tenants or customers varies. The analytic obtains the correct customer-specific data at the edge node for each customer or tenant. The analytic needs only a certain customer's data, since it is improper to share data. To obtain the data, the edge node may have the IP address and the credentials of the tenant and uses this to obtain the correct data.

In other aspects, the edge node and the nodes of the cluster may be physical or virtual machines. The edge node and the nodes of the cluster may execute on the same or different physical machines (e.g., control circuits or other types of processing devices).

The data and the analytic are sent down from the edge node to the cluster. In aspects, the cluster is a virtual machine and is where the analytic is executed. The cluster is formed of containers (defined as software processes or instances of software) that have certain file access privileges. Some containers have full access privileges to files, some containers have partial access privileges, and some containers have no access privileges at all. The files include data or may be programs themselves.

In some instances, the container's rules and the code that implements the analytic may be in conflict. In this situation and if the analytic code contradicts a container rule, then the container rule prevails. Thus, if the analytic was programmed to “execute the XYZ code”, but the container rule (preprogrammed or preconfigured) had a rule that stated “do not access the XYZ code,” the container rule prevails.

Advantageously, the present approaches prevent the unauthorized use of data by tenants. These approaches also isolate tenant jobs (e.g., software programs or analytics) so that long running or high resource consuming jobs do not take the resources of other jobs.

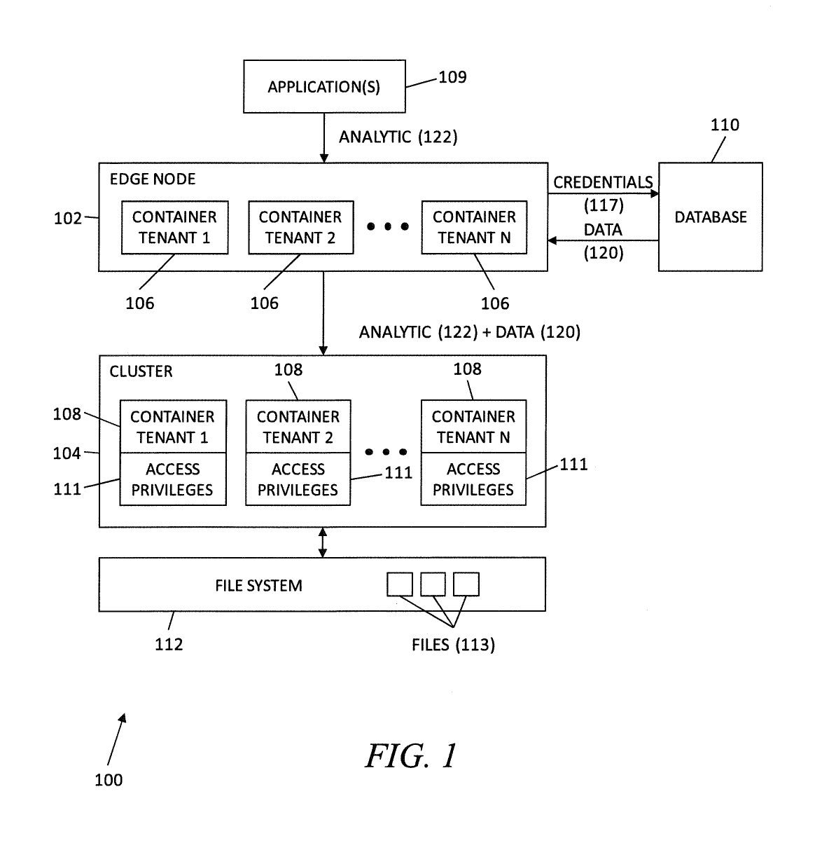

Referring now to FIG. 1, one example of a system 100 that provides containerization of analytic execution at a cluster is described. The system 100 includes an edge node 102 and a cluster 104. The cluster 104 includes one or more software containers 108, and is communicatively coupled to the edge node 102. Each of the containers 108 enforces a set of access privileges 111 for files 113 being accessed from a file system 112. The edge node 102 also includes one or more containers 106. The edge node 102 communicates with a database 110. The cluster 104 communicates with files in the file system 112. Although one edge node 102 and cluster 104 are shown in FIG. 1, it will be appreciated that multiple edge nodes and/or clusters may be used.

The edge node 102 is configured to obtain tenant-specific data 120 required for use by a software analytic 122 (which may be received from an application 109. The edge node 102 can be thought of as a staging area for initially obtaining and/or storing analytics and data.

The application 109 may be software that is utilized by different users. This application software 109 utilizes analytics 122. Analytics 122 perform different types of tasks such as counting the number of binary ones and zeros in a data streams. Analytics 122 are utilized and applied to data created by different types of industrial machines.

The edge node 102 and the cluster 104 may be implemented on the same or different control circuits or processing devices. When the edge node 102 is implemented on the same control circuit or processor as the cluster 104, the edge node is logically or virtually separate from the cluster. In other cases, edge node 102 and the cluster 104 are implemented on physically separate and different control circuits or processors.

The software containers 106 are software processes or instances of software that access the database 110. In aspects, the software containers 106 may be executable code that is executed on a processor or a control circuit. The software containers 106 may store and use security credentials 117 of tenants to access and obtain data from the database 110.

The cluster 104 is formed of the software containers 108. The software containers 108 are software processes or instances of software that have certain file access privileges 111. Some of the containers 108 may have full access privileges, some of the containers 108 may have partial access privileges, and some of the containers 108 may have no access privileges at all. The files at the file system 112 include data or may be programs themselves.

The database 110 is any type of memory storage device. In examples, the database 110 stores time series data that is obtained from industrial machines. Time series data may include measurements of parameters such as temperatures, pressures, or velocities. Other examples of time series data are possible. As used herein, “tenant” refers to a specific user and may be a person, an organization (e.g., a school, class, or business to mention a few examples), group of people, or group of organizations.

In one example of the operation of the system of FIG. 1, the cluster 104 is configured to receive the tenant-specific data 120 and the analytic 122 from the edge node 102. The cluster 104 is configured to route the user data 120 and the analytic 122 to a selected container 108 within the cluster 104, and the selected container 108 executes the analytic 122 such that the data accessed or utilized by the analytic (e.g., from the files 113) is protected from access by other tenants utilizing the cluster 104.

In aspects, the containers 108 comprise one or more pre-programmed rules. In some examples, the pre-programmed rules for each of the containers 108 takes priority over file access requests made by the analytic 122.

In other examples, the files 113 include data files or executable code files. In still other examples, the edge node 102 utilizes an IP address and security credentials 117 may be used to obtain the tenant-specific data. In examples, the security credentials 117 include a password or a key. In this case, the IP address is accessed and the security credentials presented at the IP address to obtain the data. The data may, in examples, include time series data obtained from industrial machines.

The containers 106 and 108 described herein may be executed as computer instructions that are executed on or by one or more control circuits. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit may be configured (for example, by using corresponding programming stored in a memory as will be well understood by those skilled in the art) to carry out one or more of the steps, actions, and/or functions described herein.

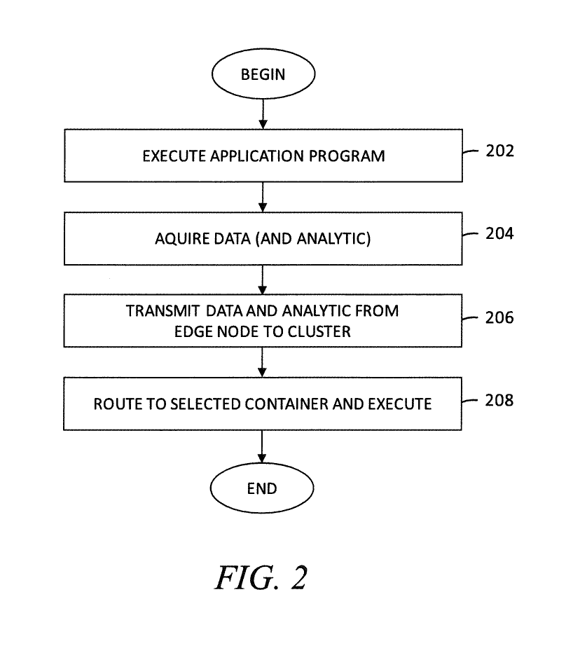

Referring now to FIG. 2, one example of an approach for the containerization of data is described. It will be understood that the example of FIG. 2 is implemented according to a specific architecture and structure. An application may be executed at a control circuit, and the application includes or utilizes analytics. An edge node communicates with the analytic and a cluster communicates with the edge node. In examples, the edge node and the cluster may be deployed at the cloud, and the application may be executed locally such as at an industrial site. The application may communicate with the edge node via a network. The application may communicate directly with the edge node, but does not communicate directly with the cluster. The cluster communicates with a file system that stores files. The files may store data, may be executable code, or may be combinations of data and executable code.

At step 202, the application program is executed and the application program includes an analytic. In examples, the application program interfaces with the user, while the analytics do not directly interface with the user. The analytic may be sent to the edge node, or may be initially deployed at the edge node.

At step 204, tenant-specific data required for use by the software analytic is obtained at an edge node is obtained. The software analytic is associated with a single tenant and the data that is acquired may be associated with that tenant only.

At step 206, the tenant-specific data and the analytic are transmitted from the edge node to the cluster, which includes one or more software containers. Each of the containers at the cluster enforces a set of access privileges for files being accessed by the analytic.

At step 208, the user data and the analytic are routed to a selected container within the cluster and the selected container executes the analytic such that the data accessed by the analytic at the container is protected from access by other tenants utilizing the cluster. Routing may be based upon the identity of a tenant.

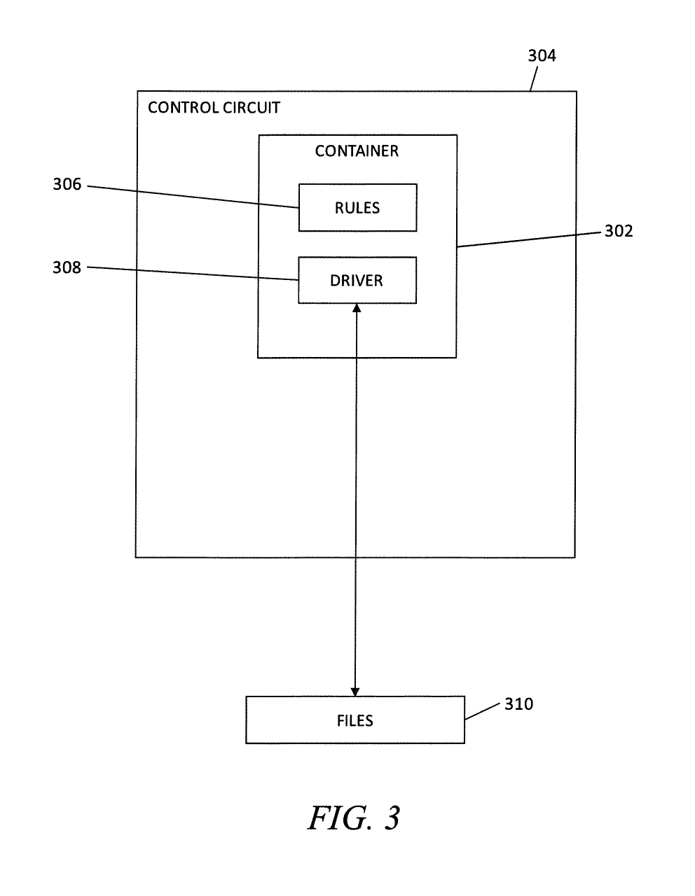

Referring now to FIG. 3, one example of a container 302 utilized at a cluster (e.g., the cluster 104 of FIG. 1) is described. The container 302 may be software or an instance of software that is executed on a control circuit 304. The container 302 includes one or more pre-programmed rules 306 and a driver 308. In one example, the pre-programmed rules for each of the containers takes priority over file access requests made by the analytic.

In other aspects, the rules 306 includes a set of access privileges that determine whether the container 302 has full access, partial access, or no access to files (e.g., data files or executable code files). The access privileges may be unique as between different containers, or may be the same for all or some containers.

The driver 308 interfaces with a file system (e.g., the file system 112 od FIG. 1). The driver 308 may implement and enforce the rules 304 and act to obtain software files 310 and receive the files 310 once the file has been requested and accessed. In examples, the rules 306 may specify files which the container 302 can access and/or files the container cannot access. The rules 306 may be stored in a memory storage unit as any appropriate structure such as a table.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method of containerization of analytic execution at a cluster, comprising:
obtaining tenant-specific data required for use by a software analytic at an edge node, the software analytic being associated with a single tenant;
transmitting the tenant-specific data and the analytic from the edge node to a cluster of one or more software containers, wherein each of the containers at the cluster enforces a set of access privileges for files being accessed;
wherein the user data and the analytic are routed to a selected container within the cluster and the selected container executes the analytic such that the data accessed by the analytic at the container is protected from access by other tenants utilizing the cluster.

2. The method of claim 1, wherein each of the containers comprise one or more pre-programmed rules.

3. The method of claim 2, wherein the pre-programmed rules for each of the containers takes priority over file access requests made by the analytic.

4. The method of claim 1, wherein the set of access privileges includes full access, partial access, or no access.

5. The method of claim 1, wherein the files include data files or executable code files.

6. The method of claim 1, wherein an IP address and security credentials are utilized to obtain the tenant-specific data.

7. The method of claim 6, wherein the security credentials include a password or a key.

8. The method of claim 1, wherein the access privileges comprise a unique set of access privileges.

9. A system that provides containerization of analytic execution at a cluster, comprising:
an edge node that is configured to obtain tenant-specific data required for use by a software analytic;
a cluster of one or more software containers, the cluster being communicatively coupled to the edge node, wherein each of the containers enforces a set of access privileges for files being accessed;
wherein the cluster is configured to receive the tenant-specific data and the analytic from the edge node;
wherein the cluster is configured to route the user data and the analytic to a selected container within the cluster, and the selected container executes the analytic such that the data accessed by the analytic is protected from access by other tenants utilizing the cluster.

10. The system of claim 9, wherein each of the containers comprise one or more pre-programmed rules.

11. The system of claim 10, wherein the pre-programmed rules for each of the containers takes priority over file access requests made by the analytic.

12. The system of claim 9, wherein the set of access privileges includes full access, partial access, or no access.

13. The system of claim 9, wherein the files include data files or executable code files.

14. The system of claim 9, wherein the edge node utilizes an IP address and security credentials are utilized to obtain the tenant-specific data.

15. The system of claim 14, wherein the security credentials include a password or a key.

16. The system of claim 9, wherein the access privileges comprise a unique set of access privileges.
